(19) United States
(12) Patent Application Publication
(10) Pub. No.: US 2025/0326452 A1
(43) Pub. Date: Oct. 23, 2025

(54) HEAVY-DUTY TRANSPORT MODULE VEHICLE, TRANSPORT VEHICLE FOR A PLURALITY OF HEAVY-DUTY TRANSPORT MODULE VEHICLES AND ACCOMMODATION SECTION FOR SUCH A TRANSPORT VEHICLE

(71) Applicant: GOLDHOFER AKTIENGESELLSCHAFT, Memmingen (DE)

(72) Inventor: Thomas Häring, Stetten (DE)

(21) Appl. No.: 18/861,757

(22) PCT Filed: Apr. 25, 2023
(86) PCT No.: PCT/EP2023/060729

§ 371 Date: Oct. 30, 2024

(30) Foreign Application Priority Data
May 2, 2022 (DE) 10 2022 110 682.9

(51) Int. Cl. B62D 59/04; B62D 61/10

(52) U.S. Cl. CPC B62D 59/04; B62D 61/10

(57) ABSTRACT

Disclosed is a heavy-duty transport module vehicle having at least one pair of drivable axle assemblies which are rotatably fixedly arranged on a common carrier, a load-bearing unit with a load-bearing surface, the carrier being rotatably connected to the load-bearing unit, a control device for controlling the drive units of the axle assemblies, and a communication device for two-way communication with further heavy-duty transport module vehicles and/or an external control, wherein the communication device also serves for two-way data exchange with the control device.

The invention relates to a heavy-duty transport module vehicle with at least two axle assemblies.

In the context of the present invention, heavy load transport is referred to if the load for which each of the load-bearing axle assemblies is designed has a value of at least 4 t, preferably at least 5 t, even more preferably at least 6 t.

Also, in the context of the present invention a module vehicle is understood to mean a vehicle that can be connected up to one or more other identical or similarly designed module vehicles, that is to say can be rigidly connected mechanically and/or coupled as regards control technology in order to be able to transport the heavy load.

From DE 1 655 176 A1 a heavy-duty transport module vehicle is known which has a plurality of axle assemblies, each of which can be steered separately, in other words each of which can pivot about a pivot axis running in the vertical direction of the heavy-duty transport module vehicle. The axle assemblies are arranged on a common frame, on which a load-bearing unit is arranged by means of a ball and socket joint and can be raised and lowered in the vertical direction. A number of such heavy-duty transport module vehicles can be combined to form a cluster, i.e. a group of vehicles that are not mechanically rigidly connected, in order to be able to transport a load together. Each of the heavy-duty transport module vehicles has a driver's cab. The motive energy required to drive the heavy-duty transport module vehicle can either be supplied externally via cables or generated on board by means of an internal combustion engine. Control signals can furthermore be conveyed via the cable, which are executed by the driver. The control signals can also be given acoustically and/or optically. An automatic remote control via an external command center is however also envisaged. This type of heavy-duty transport module vehicle has not been adopted in practice because it is too costly to operate for transport operations. To operate the transport system requires either a large number of personnel if each vehicle has to be manned, or the external command center is loaded with too many tasks that have to be carried out simultaneously in order to be able to remotely control all vehicles at the same time.

In practice, heavy-duty transport module vehicles are therefore usually used, which are assembled into a group before the heavy load is transported, i.e. a group of vehicles mechanically rigidly connected to one another so as to be able to transport a load jointly. Such vehicles are for example marketed by the applicant under the name “PST”. In addition to the mechanically rigid connection of the vehicles, the necessity of having to coordinate the steering rods of the heavy-duty transport module vehicles of the group is also regarded as time-consuming.

The object of the present invention is to remedy this situation.

This object is achieved according to the invention by a heavy-duty transport module vehicle, comprising:
at least one pair of independently drivable axle assemblies which are arranged on a common carrier with mutually aligned axes and are pivotally fixed relative to the carrier with respect to a pivoting movement about an axis running in a height direction of the carrier.
a load-bearing unit with a load-bearing surface, wherein the carrier is connected to the load-bearing unit so as to be able to rotate about an axis of rotation running orthogonally to the load-bearing surface,.
a control device which is designed and intended to control at least one drive unit of each of the drivable axle assemblies, and.
a communication device which is designed and intended for two-way communication with at least one further, substantially structurally identical heavy-duty transport module vehicle and/or a superordinate external control,
   wherein the communication device is further designed and intended for two-way data exchange with the control device.

A first advantage of the heavy-duty transport module vehicle according to the invention is that no separate steering device needs to be provided for the axle assemblies. Instead, each pair of drivable axle assemblies can be controlled by driving the two axle assemblies of the respective pair via the control device at different speeds and/or in opposite directions of rotation. Since the axle assemblies are arranged on the carrier assigned to them in a non-pivotable manner with respect to an axis running in the vertical direction, this causes a rotation of the carrier about the axis of rotation running orthogonal to the load-bearing surface. This also applies if a plurality of pairs of axle assemblies are attached to the load-bearing unit.

If the heavy-duty transport module vehicle has only a single pair of axle assemblies, the carrier can be formed by the frame of the heavy-duty transport module vehicle, on which a separate load-bearing unit is then arranged so as to be able to rotate relative to this frame. If however the heavy-duty transport module vehicle has a plurality of pairs of axle assemblies, then to each of these pairs a separate support element can be assigned as carrier, and the load-bearing unit can be formed by the frame of the heavy-duty transport module vehicle on which the plurality of support elements are rotatably arranged.

Even if this is not necessary according to the invention, the at least one carrier does not necessarily have to be directly rotatably connected to the load-bearing unit. In principle it is also conceivable according to the invention that the at least one carrier is rotatably connected to an intermediate unit, which in turn is rotatably connected to the load-bearing unit.

The possibility of steering each pair of axle assemblies individually by the control device provides, in cooperation with the communication device, a further advantage of the heavy-duty transport module vehicle according to the invention. Indeed, it can be combined with at least one other, essentially structurally identical heavy-duty transport module vehicle to form a cluster of heavy-duty transport module vehicles, in other words an arrangement of vehicles that are if necessary mechanically connected via the joint load they are carrying. Coordination with at least one other heavy-duty transport module vehicle and, optionally, with a superordinate external control system is ensured via the communication device. This can on the one hand both receive and send data (two-way communication), and on the other hand it can both forward the received data to the control device and receive status data from it (two-way data exchange). In this way, the synchronization of the movement of the individual vehicles of the cluster with the aim of a joint transport of the load can also be ensured through the interaction of the control device and the communication device.

To form the cluster, the heavy-duty transport module vehicles can be maneuvered individually underneath the load, that is to say independently of the other heavy-duty transport module vehicles, to a location designated for them. Their respective load-bearing surface can then be brought into load-bearing engagement with the load. However, as already mentioned, the heavy-duty transport module vehicles are not mechanically connected to one another, so that they do not form a vehicle network in the sense defined above, but form a vehicle cluster in the sense of the invention. Once all heavy-duty transport module vehicles have been arranged at the location intended for them and brought into load-bearing engagement with the load, they can then be synchronized and coupled as regards their control via control technology by means of the communication device and the control device. From this point on, the cluster of vehicles can then be controlled jointly so that it can transport the load to another location.

In a development of the invention it is envisaged that a further axle assembly is provided, which is arranged on the carrier so as to be able to pivot about a pivot axis running in the vertical direction of the carrier. In principle, it is indeed conceivable to provide only the pairs of axle assemblies already mentioned on the heavy-duty transport module vehicle. In this case the driving stability of the vehicle could for example be achieved by control technology, in the case of a single pair of axle assemblies by a drive control for example. as is known from vehicles of the “inverted pendulum” type (such as the Segway®). This also applies in a similar manner to heavy-duty transport module vehicles that have multiple pairs of axle assemblies, the axles of which are all aligned with one another in a predetermined steering position. However, to simplify control technology and to easily ensure driving stability, it is advantageous to provide the additional axle assembly as a support axle assembly. In particular, three axle assemblies, namely a pair of driven axle assemblies and a support axle assembly, enable a stable positioning on the driving surface on the one hand and create a compact design on the other. Again, the compact design allows a high load-bearing density (t/m² load support area) to be achieved when using multiple heavy-duty transport module vehicles.

In order to be able to further increase the driving stability of the heavy-duty transport module vehicle according to the invention, it is further proposed that the drivable axle assemblies on the one hand and the further axle assembly on the other hand are arranged on opposite sides of a plane which firstly extends parallel to the axes of the drivable axle assemblies, secondly runs in the height direction of the carrier, and thirdly passes through the center of gravity of the heavy-duty transport module vehicle. This ensures that all three axle assemblies are always in contact with the driving surface when driving without a load. The stability of this contact can be further increased if the distance of the driven axis assemblies from the plane is between 5 cm and 10 cm.

Simply for the sake of completeness, it should be mentioned that the additional axle assembly can be a non-driven axle assembly. The manufacturing costs for the heavy-duty transport module vehicle can be reduced in this way. Furthermore, the wheel or wheels of the additional axle assembly can have a smaller diameter than the wheels of the driven axle assemblies, which saves installation space and thus enables a more compact design of the heavy-duty transport module vehicle.

In a further development of the invention, it is proposed that all axle assemblies are designed to be height-adjustable relative to the carrier. This enables the heavy-duty transport module vehicle to drive underneath a load when in a lowered state and then pick the load up by jointly adjusting the height of the axle assemblies. To create the load-bearing engagement, no separate lifting device therefore needs to be provided between the load-bearing surface and the carrier, which reduces the manufacturing costs.

The height adjustability also enables the additional axle assembly, which of course serves primarily to ensure driving stability in the unloaded state, to be raised when the driving stability is ensured by the surface contact of the load-bearing surface with the load and the interaction with other heavy-duty transport module vehicles in the cluster mediated by the load. In this case the additional axle assembly therefore does not need to have the load-bearing capability of the driven axle assemblies. Rather, it is sufficient if it can bear the weight of the heavy-duty transport module vehicle. It can therefore be designed to be correspondingly small, which improves the overall compact design of the heavy-duty transport module vehicle.

The possibility of being able to dispense with a lifting device between the load-bearing surface and the carrier also enables the load-bearing surface to be connected to the carrier via a slewing ring, for example a rolling element slewing ring, the diameter of which is preferably at least 25%, more preferably at least 50%, of a maximum external dimension of the heavy-duty transport module vehicle measured in the load-bearing state in the horizontal direction. The stability of the contact with the load can thereby be improved. Furthermore, it can be envisaged that the heavy-duty transport module vehicle comprises at least one battery pack, which is preferably arranged substantially completely within the confines of the carrier. In this way the heavy-duty transport module vehicle can also become self-sufficient in terms of its energy supply, in other words independent of external energy supplies during load transport. Between two load transport operations, the at least one battery pack can be recharged at a suitable charging station. In addition, the drive energy required for the operation of the heavy-duty transport module vehicle can be provided in an environmentally friendly manner by using the at least one battery pack according to the invention.

In a further development of the invention, it is envisaged that the control device can be switched between an individual mode and a collective mode. The individual mode can enable a single heavy-duty transport module vehicle to be controlled in this way. In particular, as explained in the introduction, the heavy-duty transport module vehicle in question is able to be arranged underneath the load at a predetermined site. Once all heavy-duty transport module vehicles have been arranged underneath the load at the designated sites, individual mode can be switched to collective mode so that the majority of vehicles—as also described in the introduction—can then be controlled together as a cluster of vehicles to transport the load.

In this context, it is furthermore advantageous according to the invention if the control device is designed and intended to synchronize the heavy-duty transport module vehicle with other heavy-duty transport module vehicles in a synchronization phase after switching to the collective mode.

For this purpose, an environment detection unit can be assigned to the control device, which is designed and intended to detect the distance and/or the direction and/or detect an identification of at least one further heavy-duty transport module vehicle.

In this context, it is furthermore advantageous if the communication device is designed and intended to receive environmental detection data from other heavy-duty transport module vehicles and to forward the data to the control device. This enables the heavy-duty transport module vehicle to determine its position within the entire cluster of heavy-duty transport module vehicles, for example by means of trilateration and/or triangulation. This is an advantage, for example, if it is a question of determining your own steering angle based on the predetermined steering angle for the group.

Furthermore, it can be advantageous if the control device is further assigned a position detection unit which is designed and intended to detect the absolute position of the heavy-duty transport module vehicle and/or its orientation in space. On the one hand, this enables the heavy-duty transport module vehicle to be aligned according to a predetermined orientation, for example so that its direction of travel points north. This is particularly advantageous when a plurality of heavy-duty transport module vehicles is used simultaneously to transport a common load. Once all heavy-duty modules have picked up the load, they can all align themselves according to the specified orientation so that their steering directions are aligned parallel to each other. Starting from this “basic state”, further steering movements can then be performed. On the other hand, this makes it possible to determine the absolute position of the heavy-duty transport module vehicle and thus also of the entire cluster in the surrounding area, which for example in conjunction with map data of the surrounding area enables the cluster to be moved safely, in particular in a collision-free manner, to the target destination. In this context it may also be advantageous if the control device of each heavy-duty transport module vehicle is furthermore designed and intended to receive information about the arrangement of the heavy-duty transport module vehicle relative to the load via the assigned communication device.

The environment detection unit and/or the position detection unit may for example comprise one or more of the following commonly available units:
The absolute position of the heavy-duty transport module vehicle can be determined by means of a GNSS receiver (GNSS—Global Navigation Satellite System). In this case, the signal of the L1 frequency band and the phase shift of the L5 frequency band can be used in a manner known per se to increase the precision of the position determination.
The orientation of the heavy-duty transport module vehicle relative to its surroundings can also be determined by means of a compass and/or a gyroscope.
Wi-Fi® and/or Bluetooth® can be used to determine the relative position and/or relative orientation of the heavy-duty transport module vehicle in relation to the other heavy-duty transport module vehicles in the cluster.
In principle, distances could be determined using the RSSI method (RSSI-Received Signal Strength Indication). However, this method has the disadvantage that the signal strength is disproportionately attenuated if the signal has to pass through a body, which means that the determined distance appears to be greater than the actual distance.
This problem can be avoided for example by means of the RTT method (RTT-Round Trip Time), in which the distance is determined using a travel time measurement.
Finally, the direction in which the neighboring heavy-duty transport module vehicle is located can be determined by means of the AoA method (AoA—Angle of Arrival). However, this method requires the use of an antenna array.
When using Bluetooth®, the signal of the requesting heavy-duty transport module vehicle can be returned by one or more Bluetooth® beacons of the responding heavy-duty transport module vehicle together with its unique identification. When using at least two Bluetooth® beacons, the relative orientation of the two heavy-duty transport module vehicles can then also be determined.

All these methods are known per se, and by appropriate combination of these methods the relative position of the heavy load transport module vehicles of the cluster can be determined with an accuracy of less than 10 cm, preferably less than 5 cm.

In an initialization phase of the collective mode, the heavy-duty transport module vehicles can thus determine their respective position within the cluster and, if necessary, also relative to the load. This position later plays a crucial role in determining the individual steering angles for the individual pairs of axle assemblies. Furthermore, the heavy-duty transport module vehicles can also align themselves with respect to one another during this initialization phase, so that their steering directions are initially aligned all parallel to one another. The direction can be specified by the external control.

In an operating phase of the collective mode, the heavy-duty transport module vehicles can then be controlled together. On the one hand, this includes joint movement, and specifically both when driving straight ahead and when cornering. As already mentioned, only the steering angle for the entire cluster of heavy-duty transport module vehicles can be specified externally, in other words by the external control, while the control devices of the individual heavy-duty transport module vehicles determine the steering angle that is important for the respective heavy-duty transport module vehicle on the basis of the specified cluster steering angle and the position in the cluster itself. In this connection it is of course advantageous to ensure that all heavy-duty transport module vehicles of the cluster use the same version of the computing software.

When transporting the load, it is also important to compensate for any unevenness in the driving surface. For this purpose, an averaged initial level for the height adjustment device of the axle assemblies can be calculated and set in the initialization phase of the collective mode for all pairs of axle assemblies. If the height adjustment device is a fluidic, in particular hydraulic, height adjustment device, the corresponding initial axle pressure can thus also be determined and stored. If one of the heavy-duty transport module vehicles comes into the range of its compression or rebound limits during the operating phase of the collective mode, it can communicate this to the other heavy-duty transport module vehicles via the communication device. Furthermore, this can also be communicated to the operator in the external control system as an advance warning. In this case the central control system can determine a reaction for each individual member of the cluster according to predefined rules and transmit the corresponding individual settings to the individual heavy-duty transport module vehicles. Of course, this determination can also be carried out individually by each individual control device of the heavy-duty transport module vehicles. If the problem cannot be resolved by an overall response, an appropriate warning message can be issued to the operator.

In order to achieve a compact design and thus a high load-bearing density (t/m² supporting area of the load), it can further be envisaged that in plan view all components are arranged within a substantially circular contour, the diameter of which is preferably at most 300 cm, more preferably at most 275 cm, even more preferably at most 220 cm.

For the sake of completeness, it should be mentioned at this point that the heavy-duty transport module vehicle according to the invention is advantageously and preferably an unmanned heavy-duty transport module vehicle.

Furthermore, it should also be said that each of the axle assemblies has at least one wheel, wherein the wheel or at least one of the wheels can have twin tires.

According to a second aspect, the invention relates to a transport vehicle for a plurality of heavy-duty transport module vehicles according to the invention that has a container for housing each of the heavy-duty transport module vehicles.

Heavy-duty transport module vehicles of the type according to the invention are usually used for individual special transports. This means that they have to be brought to the respective use site and then transported away from the site once the transport task has been completed. The transport vehicle according to the invention for example can be used for this purpose.

In order to be able to arrange as many heavy-duty transport module vehicles as possible on the transport vehicle, it is proposed that at least two of the supports are arranged above one another in the vertical direction.

In principle, it would of course be conceivable to use a heavy-duty forklift truck to insert the heavy-duty transport module vehicles into the at least one upper and, if necessary, also into the lowest container. For this purpose the heavy-duty forklift truck would then also have to be brought to the use site and transported away again. According to the invention it is therefore preferred that the transport vehicle comprises at least one lifting device which is designed and intended to lift a heavy-duty transport module vehicle arranged in the lowest container into the or one of the upper containers. Of course, the heavy-duty transport module vehicles can also be lowered from their respective containers into the lowest container by means of the lifting device.

Not only in this context, but also in general, it is further proposed that at least one container, preferably a plurality of containers, even more preferably all containers, is/are assigned at least one securing element which is designed and intended to secure a heavy-duty transport module vehicle arranged in the respective container in the latter. This securing element can, after lifting a heavy-duty transport module vehicle, grip it from underneath for example and, if necessary in conjunction with at least one other securing element, hold it in the container while the lifting device is lowered again to lift another heavy-duty transport module vehicle. In addition, the securing element can also secure the heavy-duty transport module vehicle for transport by means of the transport vehicle.

In a development of the second aspect of the invention, it may be envisaged that at least one receiving section of the transport vehicle comprising the containers can be lowered onto the ground. This enables a heavy-duty transport module vehicle arranged in the lowest container to move into or out of the container without external assistance, in other words using only its own drive means.

Not only in this context, but also in general, it is also advantageous if the lowest container has a lateral opening in relation to the direction of travel of the transport vehicle, which is dimensioned such that it enables a heavy-duty transport module vehicle to be moved into or out of the container through this opening. In this way the heavy-duty transport module vehicle can easily drive into or out of the container from the side.

In order to be able to arrange as many heavy-duty transport module vehicles as possible on the transport vehicle, it is furthermore proposed that at least two of the containers are arranged behind one another in the longitudinal direction of the transport vehicle.

As regards transport using the public road network, it is also advantageous if at least the receiving section of the transport vehicle holding the containers does not exceed the dimensions of ISO containers.

In a development of the second aspect of the invention, it can further be envisaged that the transport vehicle is designed as a trailer vehicle which can be brought into towing connection with a towing vehicle not belonging to the transport vehicle, for example by means of a gooseneck connection.

Furthermore, the transport vehicle can include a power supply unit for charging the battery packs of the heavy-duty transport module vehicles.

Although one embodiment of the transport vehicle has been described above, in which the heavy-duty transport module vehicles are arranged in the containers of the transport vehicle in their usual operating position, i.e. with a substantially horizontal load-bearing surface, it should be mentioned at this point for the sake of completeness that other embodiments are in principle also conceivable. Just by way of example, it should be mentioned that the heavy-duty transport module vehicles could also be arranged in the containers with a substantially vertical load-bearing surface. In this case no lifting devices would then be required, but instead swivel devices that grip the heavy-duty transport module vehicles and swivel them from their usual operating position, in other words with an essentially horizontal load-bearing surface, into the transport position with a substantially vertical load-bearing surface.

According to a third aspect, the invention relates to a receiving section for such a transport vehicle.

The invention is explained in more detail hereinafter with reference to an exemplary embodiment and the accompanying drawings. In the drawings:

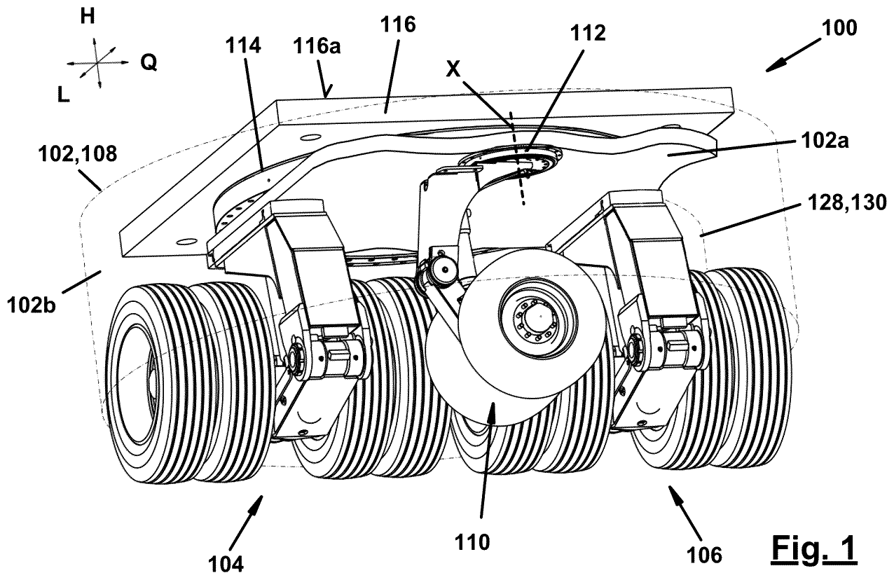

FIG. 1 is a perspective and partially schematic view obliquely from below of a heavy-duty transport module vehicle according to the invention;

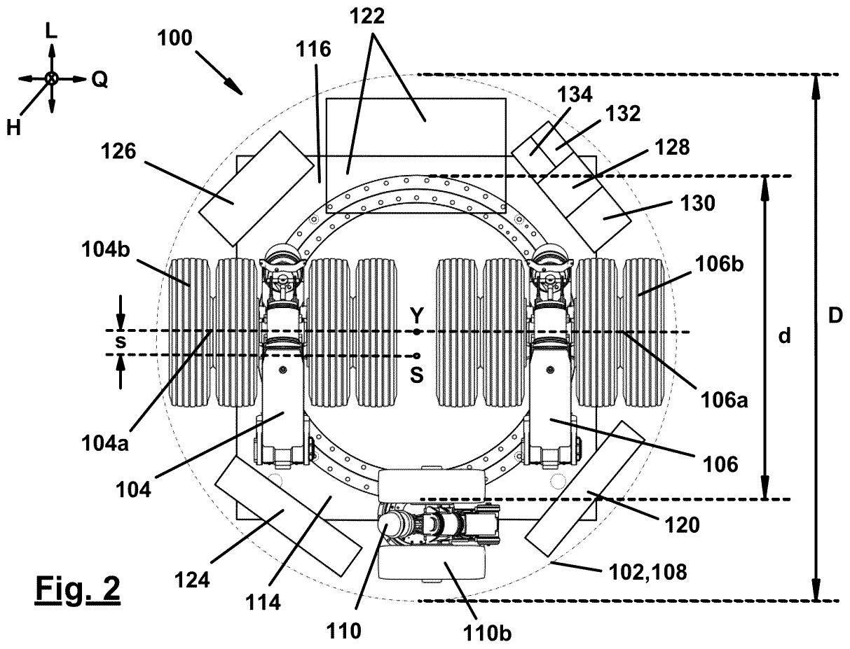

FIG. 2 is a schematic bottom view of the heavy-duty transport module vehicle according to FIG. 1;

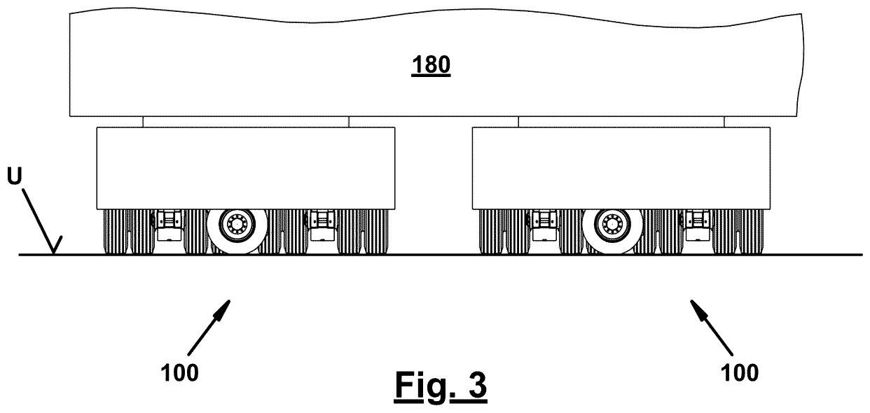

FIG. 3 is a side view of a plurality of heavy-duty transport module vehicles according to the invention arranged underneath a load;

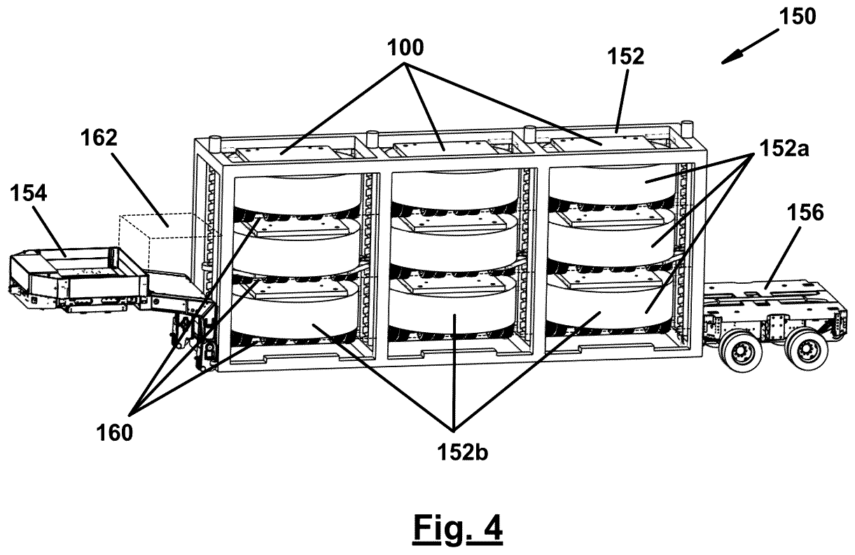

FIG. 4 is a perspective view of a fully loaded transport vehicle according to the invention that is used to transport a plurality of heavy-duty transport module vehicles according to the invention; and

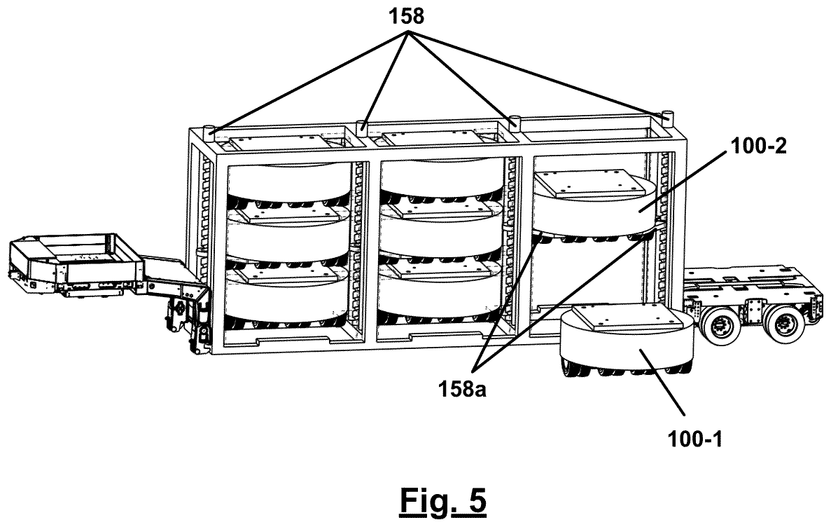

FIG. 5 is a view similar to FIG. 4 of the transport vehicle in a partially unloaded state.

In FIG. 1, a heavy-duty transport module vehicle according to the invention is generally denoted by 100. The heavy-duty transport module vehicle 100 comprises a frame 102, which is indicated in FIG. 1 in the form of a cylinder shown in dashed lines. Only a part of the upper boundary wall 102a of the frame 102 is physically shown. This boundary wall 102a forms the actual frame on which the other components of the heavy-duty transport module vehicle 100, to be explained hereinbelow, are arranged. Furthermore, the frame 102 also comprises a peripheral wall 102b, which simply acts as a cladding of the heavy-duty transport module vehicle 100.

The heavy-duty transport module vehicle 100 has a vertical direction H, a transverse direction Q and a longitudinal direction L, each of which run orthogonally to one another in pairs.

On the underside of the upper boundary wall 102a of the frame 102, two drivable axle assemblies 104 and 106 are arranged in a rotationally fixed manner with respect to rotation about a direction parallel to the vertical axis H. The frame 102 thus forms the support 108 of the two axle assemblies 104, 106. Furthermore, a non-driven support axle assembly 110 is arranged on the underside of the upper boundary wall 102a of the frame 102, and by means of a slewing ring 112 can rotate about an axis X running parallel to the vertical axis H.

A slewing ring 114 is arranged on the upper side of the upper boundary wall 102a of the frame 102, which ring in turn carries a load-bearing unit 116 with a load-bearing surface 116a. By means of the slewing ring 114, the load-bearing unit 116 and the frame 102 can be rotated relative to one another about an axis Y running parallel to the vertical axis H. (see FIG. 2). In order to ensure a stable support of the load, the value of the diameter d of the slewing ring 114 is at least a quarter, preferably at least half, of the value of the diameter D of the frame 102. In this case, the diameter D can for example be at most 300 cm, more preferably at most 275 cm, even more preferably at most 220 cm. In this case, a maximum width of 220 cm has the advantage that the heavy-duty transport module vehicle 100 can then even be arranged in an ISO container.

As further shown in FIG. 2, the wheel axles 104a and 106a of the axle assemblies 104, 106 run through the axis of rotation Y. And, in order to ensure that all three axle assemblies 104, 106, 110 stand securely on the ground or the driving surface U (see FIG. 3), the mass distribution of the components of the heavy-duty transport module vehicle 100 is selected so that the center of gravity S of the heavy-duty transport module vehicle 100 runs on the side of the wheel axles 104a and 106a of the axle assemblies 104 and 106 facing towards the support axle assembly 110, preferably at a distance s therefrom of at least 5 cm, more preferably at a distance of at least 10 cm.

It should also be mentioned at this point that the axle assemblies 104, 106, 110 in the illustrated exemplary embodiment all have two wheels 104b, 106b, 110b, wherein the wheels of the axle assemblies 104 and 106 have twin tires and the wheels of the axle assembly 110 have single tires. In order to save installation space, the wheels of the axle assembly 110 furthermore have a smaller diameter than the wheels of the axle assemblies 104 and 106.

FIG. 2 also shows the components required for the operation of the heavy-duty transport module vehicle 100, namely a hydraulic unit 120, battery packs 122, a brake unit 124, which services the brakes of the axle assemblies 104, 106 and if necessary also 110 with brake pressure, an electrical unit 126 as well as a control device 128 and a communication device 130. All these components are preferably completely within the contour of the frame 102, in other words within the cladding 102b.

According to the invention, the control device 128 serves to control the drive motors of the drivable axle assemblies 104, 106. If the two drive motors are driven in the same direction and at the same rotational speed, the heavy-duty transport module vehicle 100 drives straight ahead. If the two drive motors are driven at different speeds or even in opposite directions, the heavy-duty transport module vehicle 100 then executes a curvilinear movement or even turns on the spot.

The drive motors of the drivable axle assemblies 104, 106 can be electric motors that are supplied with power from the battery packs 122, or hydraulic motors that are supplied with hydraulic fluid from the hydraulic unit 120.

Furthermore, the communication device 130 serves on the one hand for two-way data exchange with the control device 128, and on the other hand for two-way communication with at least one further, substantially structurally identical heavy-duty transport module vehicle and/or the external control.

As shown in particular in FIG. 1, all axle assemblies 104, 106, 110 are designed to be height adjustable relative to the frame 102. This enables the heavy-duty transport module vehicle 100, as will be explained in more detail below, to drive under a load in a lowered state and then to pick it up by joint height adjustment of the axle assemblies 104, 106, 110. This height adjustability also enables any unevenness in the ground U (see FIG. 3) to be compensated when transporting a load together with other identical or at least similarly constructed heavy-duty transport module vehicles 100. The height adjustment can be implemented fluidically, in particular hydraulically, or by electric motor.

Since heavy-duty transport module vehicles are usually used for special transports, they have to be brought to the respective use site and, after completion of the transport task, then transported away from there. For the heavy-duty transport module vehicles 100 according to the invention, the transport vehicle 150 according to the invention shown in FIGS. 4 and 5 can for example be used for this purpose.

The transport vehicle 150 comprises a receiving section 152 in which the heavy-duty transport module vehicles 100 can be held, a gooseneck section 154 by means of which the transport vehicle can be coupled to a towing vehicle, and a chassis section 156. The connection of the receiving section 152 to the gooseneck section 154 on the one hand and to the chassis section 156 on the other hand comprises lifting means (known per se and therefore not shown separately), by means of which the receiving section 152 can be lowered onto the ground.

In the illustrated exemplary embodiment, the receiving section 152 comprises a total of nine containers 152a, namely three stacks arranged behind one another in the direction of travel, each of which has three containers 152a arranged one above the other in the vertical direction. However, it is understood of course that the receiving section 152 can also have any other number of stacks and any other number of containers 152a per stack.

The respective lowermost containers 152a of each stack have a lateral opening 152b through which a heavy-duty transport module vehicle 100 can move out of the respective container 152a or into it. In this context, FIG. 5 shows a heavy-duty transport module vehicle 100-1 that has just moved out of one of the containers 152a.

In order also to enable the heavy-duty transport module vehicles arranged in the upper containers 152a to move laterally out of the receiving section 152, said receiving section 152 comprises four lifting devices 158, two of which are arranged in an end position in relation to the three stacks of containers 152a and two of which are arranged between these stacks. Each of the lifting devices 158 comprises a lifting fork or lifting plate 158a, by means of which it can engage underneath a heavy-duty transport module vehicle. By actuating the two lifting devices 158 assigned to one of the stacks of containers 152a, the heavy-duty transport module vehicles 100 can thus be raised or lowered. This is shown in FIG. 5 for the heavy-duty transport module vehicle 100-2.

Once a heavy-duty transport module vehicle 100 has been arranged in the container 152a intended for it, it can be secured there by means of securing elements 160 (indicated only schematically in FIG. 4) so that the lifting device 158 can then handle another heavy-duty transport module vehicle 100. The securing elements 160 advantageously also serve to secure the heavy-duty transport module vehicles 100 in the containers 152a during transport.

It should also be noted that the lifting forks or lifting plates 158a of the lifting devices 158 arranged between the stacks of containers 152a can be rotated by 180°, so that they can serve both adjacent stacks.

It should also be noted that the receiving section 152 preferably does not exceed the dimensions of ISO containers, so that it can also be transported independently of the gooseneck section and chassis section, for example on a truck or a railway flat car.

Finally, it should also be noted that the transport vehicle 150 may furthermore comprise at least one power supply unit 162 for charging the battery packs 122 of the heavy-duty transport module vehicles 100. The power supply unit 162 can thereby be arranged on the gooseneck section 154, as schematically illustrated in FIG. 4. However, it is additionally or alternatively also possible to arrange it on the chassis section 156 and/or in one of the containers 152a of the receiving section 152.

The operation of the heavy-duty transport module vehicles according to the invention will next be explained in more detail.

After the heavy-duty transport module vehicles 100 have been brought to the use site by means of the transport vehicle 150 (situation according to FIG. 4), they must next be moved to the load 180 to be transported (see FIG. 3). For this purpose, one heavy-duty transport module vehicle 100 after another is lowered into the lowest container 152a of the respective stack by means of the lifting devices 158 assigned to the respective stack, unless it is already present in this lowest container 152a.

If the heavy-duty transport module vehicle 100 is in the lowest container 152a, it is then activated. Next, its control device 128 is switched to individual mode, which enables the heavy-duty transport module vehicle 100 to move independently of other heavy-duty transport module vehicles, for example by means of a radio remote control that communicates with the control device 128 via the communication device 130. In this way each of the heavy-duty transport module vehicles 100 can be maneuvered to its designated location underneath the load 180. The load-bearing unit 116 can then be raised by means of the height adjustability of the axle assemblies 104, 106, 110 until its load-bearing surface 116a lies flat against the underside of the load 180.

If desired, the support axle assembly 110 can now be raised, since of course it needs to be designed only with regard to the weight of the heavy-duty transport module vehicle 100 and not to accept heavier loads. The remaining heavy load transport module vehicle 100 is stabilized by the surface contact with the load 180.

Once all heavy-duty transport module vehicles 100 have been arranged in their designated places under the load 180, their control devices 128 are all switched to collective mode.

In a synchronization phase of the collective mode, each heavy-duty transport module vehicle 100 determines independently for itself, with reference to the external environment, where it is and also its orientation. A GNSS receiver (GNSS-Global Navigation Satellite System), a compass and similar systems known per se can be used for example for this purpose. These systems may be part of a position detection unit 132 that is associated with the control device 128. On the other hand, each heavy-duty transport module vehicle 100 determines in the synchronization phase in which direction, at what distance and, where necessary, at what orientation other heavy-duty transport module vehicles 100 are located. In this case a unique identification of the other heavy-duty transport module vehicles 100 is also determined. For this purpose, for example Wi-Fi® and/or Bluetooth® and/or similar systems can be used. The last-named systems may be part of an environment detection unit 134 associated with the control device 128.

Once the environment and position detection has been completed, the detection results are transmitted to and received by the other heavy-duty transport module vehicles 100 by means of the communication device 130. Based on this data, each of the heavy load transport module vehicles 100 can determine the exact configuration of the cluster and its own position within the cluster, and use this as the basis for control during load transport, in other words during an operating phase of the collective mode. All that is required for this purpose is that all heavy-duty transport module vehicles 100 use the same software. In order to ensure this, the version number of the software used can also be transmitted.

Furthermore, it is advantageous if the position of the load relative to the cluster is also determined. This makes it easier to avoid collisions during load transport.

During load transport, the heavy-duty transport module vehicles 100 constantly exchange operating data with one another so as to be able to recognize critical situations in advance and take suitable countermeasures. For example, the heavy-duty transport module vehicles 100 can transmit the respective compression and rebound state of their axle assemblies 104, 106 and, if applicable, 110. If one of the heavy-duty transport module vehicles 100 comes within the range of its compression or rebound limits, it notifies the other heavy-duty transport module vehicles 100 of this. Furthermore, this can also be communicated to the operator in the external control as an advance warning. In this case the central control can determine a response for each individual member of the cluster according to predetermined rules and forward the corresponding individual settings to the individual heavy-duty transport module vehicles 100. Of course, this determination can also be carried out individually by each individual control device 128 of the heavy-duty transport module vehicles 100. If the problem cannot be solved by an overall response, a corresponding warning message can be issued to the operator.

1. Heavy-duty transport module vehicle, comprising:
at least one pair of independently drivable axle assemblies, which are arranged on a common carrier with mutually aligned axes and are pivotally fixed relative to the carrier with respect to a pivoting movement about an axis running in a height direction of the carrier;
a load-bearing unit with a load-bearing surface, wherein the carrier is connected to the load-bearing unit so as to be able to rotate about a rotation axis extending orthogonally to the load-bearing surface;
a control device which is designed and intended to control at least one drive unit of each of the drivable axle assemblies; and
a communication device which is designed and intended for two-way communication with at least one further, substantially identical heavy-duty transport module vehicle and/or a superordinate external control,
wherein the communication device is further designed and intended for two-way data exchange with the control device.

2. Heavy-duty transport module vehicle according to claim 1, wherein a further axle assembly is provided, which is arranged on the carrier so as to be able to pivot about a pivot axis running in the height direction of the carrier.

3. Heavy-duty transport module vehicle according to claim 2, wherein the drivable axle assemblies on the one hand and the further axle assembly on the other hand are arranged on opposite sides of a plane which firstly runs parallel to the axes of the drivable axle assemblies, secondly runs in the height direction of the carrier, and thirdly passes through the center of gravity of the heavy load transport module vehicle.

4. Heavy-duty transport module vehicle according to claim 2, wherein the further axle assembly is a non-drivable axle assembly.

5. Heavy-duty transport module vehicle according to claim 2,
wherein the wheel and wheels of the further axle assembly has and have, respectively, a smaller diameter than the wheels of the driven axle assemblies.

6. Heavy-duty transport module vehicle according to claim 1,
wherein all axle assemblies are designed to be height-adjustable relative to the frame.

7. Heavy-duty transport module vehicle according to claim 1,
wherein the load-bearing unit is connected to the carrier via a slewing ring, for example a rolling element slewing ring, the diameter of which is at least 25% of a maximum external dimension of the heavy-duty transport module vehicle determined in the load-bearing state in the horizontal direction.

8. Heavy-duty transport module vehicle according to claim 1,
further comprising at least one battery pack arranged substantially entirely within a contour of the carrier.

9. Heavy-duty transport module vehicle according to claim 1,
wherein the control device can be switched between an individual mode and a collective mode.

10. Heavy-duty transport module vehicle according to claim 9, wherein the control device is designed and intended to synchronize the heavy-duty transport module vehicle with other heavy-duty transport module vehicles in a synchronization phase after switching to the collective mode.

11. Heavy-duty transport module vehicle according to claim 1,
wherein an environment detection unit is assigned to the control device, which is designed and intended to detect the distance and/or the direction and/or to detect an identification of at least one further heavy-duty transport module vehicle.

12. Heavy-duty transport module vehicle according to claim 1,
wherein the communication device is designed and intended to receive environmental detection data from other heavy-duty transport module vehicles and to forward said data to the control device.

13. Heavy-duty transport module vehicle according to claim 1,
wherein a position detection unit is furthermore assigned to the control device, which is designed and intended to detect the absolute position of the heavy-duty transport module vehicle and/or its orientation in space.

14. Heavy-duty transport module vehicle according to claim 1,
wherein all components in plan view are arranged within a substantially circular contour, the diameter of which is at most 300 cm.

15. Transport vehicle for a plurality of heavy-duty transport module vehicles according to claim 1, which has a container for each of the heavy-duty transport module vehicles.

16. Transport vehicle according to claim 15, wherein at least two of the containers are arranged above one another in the height direction.

17. Transport vehicle according to claim 16, further comprising at least one lifting device, which is designed and intended to lift a heavy-duty transport module vehicle arranged in the lowest container into the or one of the upper containers.

18. Transport vehicle according to claim 15, wherein at least one container is assigned at least one securing element, which is designed and intended to secure a heavy-duty transport module vehicle arranged in the respective container.

19. Transport vehicle according to claim 15, wherein at least one receiving section of the transport vehicle accommodating the containers can be lowered onto the ground.

20. Transport vehicle according to claim 15, wherein the lowermost container has a lateral opening with respect to the direction of travel of the transport vehicle, which is dimensioned such that it enables a heavy-duty transport module vehicle to move through this opening into the container or out of the container.

21. Transport vehicle according to claim 15, wherein at least two of the containers are arranged behind one another in the longitudinal direction of the transport vehicle.

22. Transport vehicle according to claim 15, wherein at least the receiving section of the transport vehicle accommodating the containers does not exceed the dimensions of ISO containers.

23. Transport vehicle according to claim 15, wherein it is designed as a trailer vehicle which can be brought into towing connection with a towing vehicle not belonging to the transport vehicle, for example by means of a gooseneck.

24. Transport vehicle according to claim 15, wherein it comprises a power supply unit for charging the battery packs of the heavy-duty transport module vehicles.

25. Receiving section for a plurality of heavy-duty transport module vehicles according to claim 1, which has a container for each of the heavy-duty transport module vehicles.

26. Receiving section according to claim 25, furthermore comprising a container for each of the heavy-duty transport module vehicles, wherein at least two of the containers are arranged above one another in the height direction.
